(19) United States
(12) Patent Application Publication
(10) Pub. No.: US 2023/0342578 A1
(43) Pub. Date: Oct. 26, 2023

(54) Method of Providing Content and Features for an Object

(71) Applicant: I-chi Steven LIEN, Tsuen Wan (HK)

(72) Inventor: I-chi Steven LIEN, Tsuen Wan (HK)

(21) Appl. No.: 17/744,913

(22) Filed: May 16, 2022

(30) Foreign Application Priority Data
Apr. 20, 2022 (HK) 32022052024.3

(51) Int. Cl. G06K 19/06; G06K 1/12

(52) U.S. Cl. CPC G06K 19/06037; G06K 1/121

(57) ABSTRACT

A method of providing content and features for an object, including: preparing content and a features platform, wherein the content includes general content and personalized content, and wherein the features platform comprises online and live virtual platform, 3D graphic modelling and Metaverse; generating a quick response (QR) code and uniform resource locator (URL); linking the QR code and URL with at least one of the prepared content and the features platform; encrypting the linked QR code and URL into cloud storage; creating a unique key ID for corresponding to the QR code; and printing the QR code and URL on the object.

### FIELD OF THE INVENTION

The present invention relates to a method for providing content and features for an object, in particularly a method for providing content and features for an object by using QR code.

### BACKGROUND OF THE INVENTION

Quick Response (QR) code is a type of matrix barcode that can be read by a digital device or optical device. Said QR code may store various kinds of information as a series of pixels in a square-shaped grid. Therefore, QR codes are frequently used to track information about a product whereby users may easily use their smartphones that have built-in QR readers to read the QR codes. As such, all kinds of information can be easily and quickly accessible to anyone with a smartphone. Nowadays, QR codes are also widely used as an alternative way to make payments, connect to WIFI, or take one to a website.

The access of content via a barcode may be known in many different industries, such as the photography industry and the toy industry. For example, the integration of captured video into a photo album or a reading material in the form of barcodes. However, the content may be accessible by any person who has a digital device or optical device. This may be a lack of privacy for the content creator or content receiver. Besides, the insertion of captured video may have limited file size. Therefore, there is a need to have a method and system for providing personalized content or features and providing large file storage for insertion of captured video.

Besides, consumers may only be able to view limited information or details of a toy product on a packaging box. In due course, manufacturers now print a barcode on the packaging box to allow consumers to scan and view the details of the toy product. However, such detail information may only be limited to specifications, models and features. Hence, there is a need to have more comprehensive product details to be disclosed to attract consumers to purchase a toy, in particular a virtual platform for viewing the represented toy.

In another example, the toys in the market may have limited colours or decorations. The manufacturer may limit the production of different types of colours, decorations, or accessories due to limited demand from the consumers. These may cause consumers unable to purchase their preferred colours, decorations, or accessories for a toy. Therefore, there is a need to have an easy and simple method for consumers to purchase a customised toy on an online platform.

United States Patent No. 20130292462 A1 discloses a system and method for providing access to audio-visual (AV) content, such as music or video clips wherein provide an openly accessible code on an item or packaging associated with the item and a second code associated with the same item or packaging. Said first code and second code can be quick-response code or other scannable code or a string of alphanumeric characters. The access of content can be provided when the first code or second code is scanned or entered using a device such as computer, smartphone, or table computer. The first code is only providing a sample of the AV content to the user, wherein the second code is only providing one or limited number of times access to the user. This may not provide a good purchasing experience for the users as there is only sample AV content being disclosed before purchase and limited access after purchase. Hence, there is a need to have a system and method that provides unlimited full access of content to attract consumers to purchase the product.

United States Patent No. 20090191531 A1 discloses a method and apparatus for synchronization of sensory stimulation, such as audio, video, touch, smell and/or taste with the reading experience. Said read experience include books, magazines, textbooks, telephone directories, maps, resumes, brochures, newspapers, or other form of written or printed materials. Other forms of interaction such as interactive games or interactive tests also can be provided. One or more RFID chips are embedded in certain pages of a book to provide the sensory stimulation. Therefore, the usage of RDID in the patent may require higher cost and complicated use, in comparison with code systems. Hence, there is a need to provide a low-cost and simple method and system of providing access to content on a reading material or toys.

U.S. Pat. No. 8,808,053 B2 discloses a system and method for toy adoption and marketing. Said system and method provides a virtual world presentation to a user for entertainment wherein the virtual world includes a virtual toy representing the toy. The method for providing a virtual world presentation to a user of a toy for entertainment comprising the steps of a user obtaining the toy including a corresponding registration code; serving content, via communication network; registering the toy for allowing access to a restricted portion; and the system providing virtual world data for including in the content. Although the toys are possible to be sold to user via an online merchant, but the selection of the toys are only limited to the certain choices. Hence, there is a need to have a customised purchase online platform wherein consumer could customise a toy based on preferred colours or addition of accessories.

### BRIEF SUMMARY OF THE INVENTION

It is an objective of the present invention to provide improved method and system of providing content and/or features platform via a quick response code.

It is also an objective of the present invention to provide improved method and system of providing content in a large file storage such as cloud storage.

Accordingly, these objectives may be achieved by following the teachings of the present invention. The present invention relates to a method of providing content and features for an object, comprising of: preparing content and features platform, wherein the content comprises general content and personalized content, and wherein the features platform comprises online and live virtual platform, 3D graphic modelling and Metaverse; generating quick response (QR) code and uniform resource locator (URL); linking the QR code and URL with at least one of the prepared content and the features platform; encrypting the linked QR code and URL into cloud storage; creating unique key ID for corresponding to the QR code; and printing the QR code and URL on the object.

### BRIEF DESCRIPTION OF THE DRAWINGS

The features of the invention will be more readily understood and appreciated from the following detailed description when read in conjunction with the accompanying drawings of the preferred embodiment of the present invention, in which:

FIG. 1 illustrates a flowchart on the method of providing content and features for an object;

FIG. 2 illustrates a flowchart on the types of contents and features platform in FIG. 1;

FIG. 3 illustrates a diagram of the system for providing content and features for an object;

FIG. 4 illustrates an example method of retrieving personalized content for an object;

FIG. 5 illustrates an example method of accessing general content and features platform.

### DETAILED DESCRIPTION OF THE INVENTION

For the purposes of promoting and understanding of the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

The present invention teaches a method of providing content and features for an object, comprising of: preparing content and features platform 100, wherein the content comprises general content 101a and personalized content 101b, and wherein the features platform comprises online and live virtual platform 101c, 3D graphic modelling 101d and Metaverse 101e; generating quick response (QR) code and uniform resource locator (URL) 102; linking the QR code and URL with at least one of the prepared content and the features platform 104; encrypting the linked QR code and URL into cloud storage 106; creating unique key ID for corresponding to the QR code 108; and printing the QR code and URL on the object 110.

In a preferred embodiment of the present invention, the object comprises commodity wherein the commodity comprises photo album, gifting card, toy, kitchenware and antique.

In a preferred embodiment of the present invention, the general content 101a is prepared 100 by a retailer to a user. The general content 101a comprises object information such as specification, history, record, manufacturer's information and recipe.

In a preferred embodiment of the present invention, the personalized content 101b is prepared 100 by a content creator to a specific content receiver. The personalized content 101b comprises audio and video.

In a preferred embodiment of the present invention, the features platform is prepared 100 by a retailer to a user.

In a preferred embodiment of the present invention, the online and live virtual platform 101c comprises live showcasing a real object on an event, race, competition, and video commercials. The 3D graphic modelling 101d comprises showcasing the physical object in 3D graphic wherein the 3D graphic modelling 101d of the feature platform further comprising the step of allowing user to customize the physical object by changing the colour and sticker on the object. The customized object is deployed for commoditisation. The metaverse 101e comprises buy, host and build one's own race or competition tracking in Metaverse 101e.

In a preferred embodiment of the present invention, the unique key ID is created 108 by retailer or content creator for allowing user or content receiver respectively to access the content or features platform. Said unique key ID is provided together along with the object.

In a preferred embodiment of the present invention, the QR code and URL are optional to be printed on a physical items such as paper and stickers.

The present invention also teaches a system of providing content and features for an object, comprising of: a memory 112 to store content and features platform, wherein the content comprises general content 101a and personalized content 101b, and wherein the features platform comprises online and live virtual platform 101c, 3D graphic modelling 101d and Metaverse 101e; a processing unit 114 configured to: generate quick response (QR) code and uniform resource locator (URL) 102; link the QR code and URL with at least one of the prepared content and the features platform 104; encrypt the linked QR code and URL into cloud storage 106; create unique key ID for corresponding to the QR code 108; and a printing unit 116 configured to print the QR code and URL on the object 110.

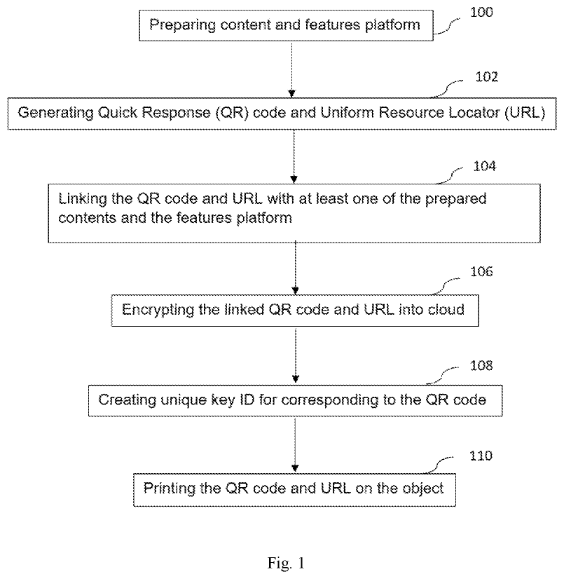

A flowchart on the method of providing content and features for an object is illustrated in FIG. 1. The method as illustrated in FIG. 1 comprises preparing content and features platform 100; generating QR code and URL 102; linking the QR code and URL with at least one of the prepared contents and the features platform 104; encrypting the linked QR code and URL into cloud storage 106; creating unique key ID for corresponding to the QR code 108; and printing the QR code and URL on the object 110. The object comprises commodity wherein the commodity includes but not limited to photo album, gifting card, toy, kitchenware and antique. The unique key ID which corresponding to the QR code is created 108 by retailer or content creator for allowing user and content receiver to access the content or features platform. The unique key ID is provided together along with the object such as on the packaging box.

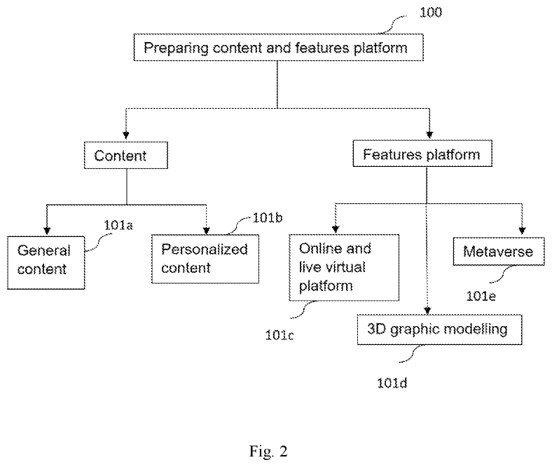

As illustrated in FIG. 2, the content comprises general content 101a and personalized content 101b. The general content 101a is prepared 100 by a retailer or manufacturer to a user wherein said general content 101a include but not limited to object information such as specification, history, record, manufacturer's information and recipe. For example, a kitchenware printed with QR code allows user to view the specifications and cooking recipes as well as manufacturer's company information and link to its company website. In another example, user may scan the QR code on an antique to view the history and record. The personalized content 101b is prepared 100 by a content creator to a specific content receiver wherein said personalized content 101b include but not limited to audio and video.

The features platform as illustrated in FIG. 2 comprises online and live virtual platform 101c, 3D graphic modelling 101d and Metaverse 101e. Accordingly, the features platform is prepared 100 by a retailer or manufacturer to a user. The online and live virtual platform 101c comprises live showcasing a real object on an event, race, competition and video commercials. The 3D graphic modelling 101d comprises showcasing the physical object in 3D graphic. In further of the said 3D graphic modelling 101d comprising the step of allowing user to customize the physical object by changing the colour, sticker, accessories and decorations on the object. Said customized object is deployed for commoditisation. The Metaverse 101e comprises buy, host and build one's own race or competition tracking in Metaverse 101e. Therefore, user or content receiver could access the content or features platform by key in the unique key ID provided on the packaging box.

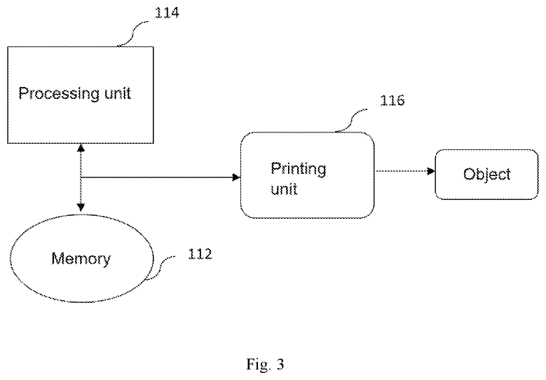

A system of providing content and features platform for an object is illustrated in FIG. 3. A processing unit 114 is coupled to a memory 112 that store content and features platform. Said processing unit 114 configured to generate QR code and URL 102, link the QR code and URL with at least one of the prepared content and the features platform 104; encrypt the linked QR code and URL into cloud storage 106, and create unique key ID for corresponding to the QR code 108. A printing unit 116 is further coupled to the system for printing the QR code and URL on the object 110.

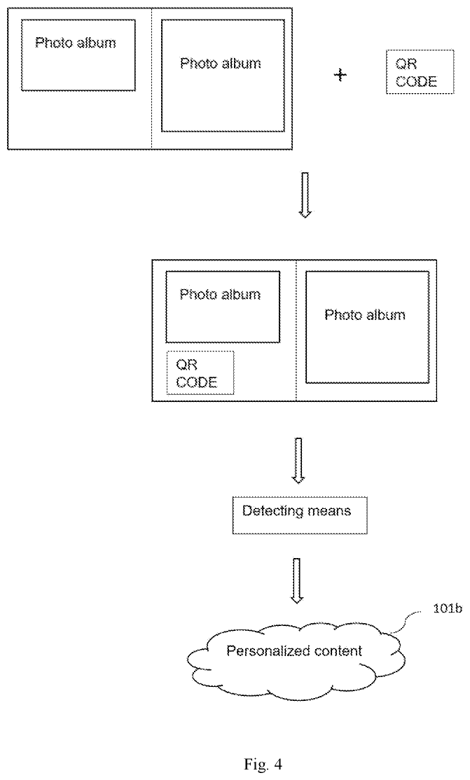

An example method of retrieving personalized content 101b for a photo album is shown in FIG. 4. A personalized content 101b such as video and/or audio is recorded by a content creator. A QR code and URL is generated 102 and linked with the video and/or audio 104. The linked QR code and URL is encrypted into cloud storage 106. Afterwards, an unique key ID is created 108 by the content creator for corresponding to the QR code wherein the unique key ID is provided together along with the photo album. The unique key ID comprises password. Subsequently, the QR code is printed on the photo album 110 as illustrated in FIG. 4. The content receiver may use any detecting means such as mobile phone with built-in QR code reader to scan the QR code on the photo album. The content receiver will be directed to a content link wherein the password is required to be key in for accessing the personalized video and/or audio 101b.

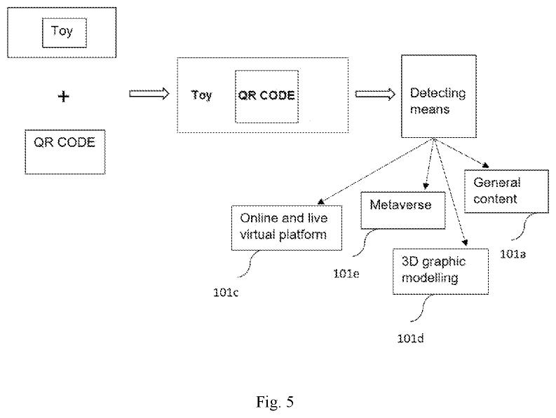

Another example method of retrieving content and accessing features platforms for a toy is shown in FIG. 5. A general content 101a comprises information of the toy such as specification, history and record of the toy is prepared 100 by a retailer or manufacturer. Then, a QR code and URL is generated 102 and linked with the prepared general content 101a and a features platform 104. The linked QR code and URL is encrypted into cloud storage 106. An unique key ID is created 108 by the retailer or manufacturer for corresponding to the QR code wherein the unique key ID is provided together along inside the toy box packaging. The unique key ID comprises password. Hence, user or consumer will only be able to obtain the password after purchased and unbox the toy. Subsequently, the QR code is printed on the toy 110 as illustrated in FIG. 5. The user or consumer may use any detecting means such as mobile phone with built-in QR code reader to scan the QR code on the purchased toy. The user or consumer will be directed to a content link wherein the password is required to be key in for accessing the general content 101a and features platform. Said features platform comprises online and live virtual platform 101c, Metaverse 101e and 3D graphic modelling 101d.

The present invention provides significantly improved method and system of providing content and/or features platform via a QR code, through encryption into cloud storage 106. Said cloud storage could provide large file storage for a content creator, retailer or manufacturer. For example, the content creator of photo album is beneficial to store a bundle of photos or videos shooting, post editing and production of hard copy in anytime. Besides, a variety number of photos, length of videos and/or audio could be stored in the cloud storage too.

The present invention provides low cost and simple method and system of providing content and/or features platform. This is because the usage of QR code is low cost and user-friendly. Besides, the present invention could provide both general content 101a and/or personalized content 101b to a user or content receiver. A password is required to access the content and therefore it is highly private and creating good marketing strategy. For example, a personalized video 101b created by a content creator is only accessible by the content receiver who having the password. In another example, the password of the toy is provided inside the packing box and therefore, use or consumer must purchase the toy to access the online and live virtual platform 101c, Metaverse 101e and 3D graphic modelling 101d. The user or consumer may unlimited access the full features such as live showcasing a real car on the road, race and video commercials; physical object in 3D graphic; and linking the purchased toy to metaverse. In addition, user may scan the QR code on the toy to the 3D toy website wherein a customized toy can be created. Said customized toy can be purchased by the user.

The present invention explained above is not limited to the aforementioned embodiment and drawings, and it will be obvious to those having an ordinary skill in the art of the prevent invention that various replacements, deformations, and changes may be made without departing from the scope of the invention.

I claim:

1. A method of providing content and features for an object, comprising of:
preparing content and a features platform;
wherein the content comprises general content and personalized content; and
wherein the features platform comprises online and live virtual platform, 3D graphic modelling and Metaverse;
generating a quick response (QR) code and uniform resource locator (URL);
linking the QR code and URL with at least one of the prepared content and the features platform;
encrypting the linked QR code and URL into cloud storage;
creating a unique key ID for corresponding to the QR code; and
printing the QR code and URL on the object.

2. The method according to claim 1, wherein the object comprises a commodity.

3. The method according to claim 2, wherein the commodity comprises a photo album, a gifting card, a toy, a kitchenware and an antique.

4. The method according to claim 1, wherein the general content is prepared by a retailer to a user.

5. The method according to claim 1, wherein the general content comprises object information such as specification, history, record, manufacturer's information and recipe.

6. The method according to claim 1, wherein the personalized content is prepared by a content creator to a specific content receiver.

7. The method according to claim 1, wherein the personalized content comprises audio and video.

8. The method according to claim 1, wherein the features platform is prepared by a retailer to a user.

9. The method according to claim 1, wherein the online and live virtual platform comprises live showcasing a real object on an event, race, competition and video commercials.

10. The method according to claim 1, wherein the 3D graphic modelling comprises showcasing the physical object in 3D graphic.

11. The method according to claim 1, wherein the 3D graphic modelling of the feature platform further comprising the step of allowing user to customize the physical object by changing the colour and sticker on the object.

12. The method according to claim 11, wherein the customized object is deployed for commoditisation.

13. The method according to claim 1, wherein the metaverse comprises buy, host and build one's own race or competition tracking in Metaverse.

14. The method according to claim 1, wherein the unique key ID is created by retailer or content creator for allowing user or content receiver respectively to access the content or features platform.

15. The method according to claim 1, wherein the unique key ID is provided together along with the object.

16. The method according to claim 1, wherein the QR code and URL are optional to be printed on a physical items such as paper and stickers.

17. A system of providing content and features for an object, comprising of:
a memory to store content and a features platform,
wherein the content comprises general content and personalized content, and
wherein the features platform comprises online and live virtual platform, 3D graphic modelling and Metaverse;
a processing unit configured to:
generate a quick response (QR) code and a uniform resource locator (URL);
link the QR code and URL with at least one of the prepared content and the features platform;
encrypt the linked QR code and URL into cloud storage;
create a unique key ID for corresponding to the QR code; and
a printing unit configured to print the QR code and URL on the object.

18. The system according to claim 17, wherein the object comprises a commodity.

19. The system according to claim 18, wherein the commodity comprises a photo album, a gifting card, a toy, a kitchenware and an antique.

20. The system according to claim 17, wherein the general content is prepared by a retailer to a user.

21. The system according to claim 17, wherein the general content comprises object information such as specification, history, record, manufacturer's information and recipe.

22. The system according to claim 17, wherein the personalized content is prepared by a content creator to a specific content receiver.

23. The system according to claim 17, wherein the personalized content comprises audio and video.

24. The system according to claim 17, wherein the features platform is prepared by a retailer to a user.

25. The system according to claim 17, wherein the online and live virtual platform comprises live showcasing a real object on an event, race, competition and video commercials.

26. The system according to claim 17, wherein the 3D graphic modelling comprises showcasing the physical object in 3D graphic.

27. The system according to claim 17, wherein the 3D graphic modelling of the feature platform further comprising the step of allowing user to customize the physical object by changing the colour and sticker on the object.

28. The system according to claim 27, wherein the customized object is deployed for commoditisation.

29. The method according to claim 17, wherein the metaverse comprises buy, host and build one's own race or competition tracking in Metaverse.

30. The method according to claim 17, wherein the unique key ID is created by retailer or content creator for allowing user or content receiver respectively to access the content or features platform.

31. The method according to claim 17, wherein the unique key ID is provided together along with the object.

32. The method according to claim 17, wherein the QR code and URL are optional to be printed on a physical items such as paper and stickers.
